(19) United States
(12) Patent Application Publication
(10) Pub. No.: US 2011/0029114 A1
(43) Pub. Date: Feb. 3, 2011

(54) METHOD, SYSTEM AND COMPUTER PROGRAM PRODUCT FOR PRODUCING A TEST ARTICLE HAVING EMBEDDED FEATURES FOR NONDESTRUCTIVE EVALUATION

(75) Inventors: Curtis Wayne Rose, Mechanicville, NY (US); John Broddus Deaton, JR., Niskayuna, NY (US)

Correspondence Address: CANTOR COLBURN LLP, 20 Church Street, 22nd Floor, Hartford, CT, 06103, US

(73) Assignee: GENERAL ELECTRIC COMPANY, Schenectady, NY (US)

(21) Appl. No.: 12/511,246

(22) Filed: Jul. 29, 2009

(51) Int. Cl. G06F 19/00

(52) U.S. Cl. 700/97

(57) ABSTRACT

A method in a computer system having a display for producing a representation of an article having embedded features including calibration target(s) or simulated defect(s) on the display. The method can include generating a representation of a test component on the display, generating a representation of embedded features on the display and combining the representations of the test component and the embedded features on the display to generate a combined representation. The method can further include converting the combined representation to a layer-by-layer format including manufacturing parameters for additive manufacturing, and producing the test article with an additive manufacturing process.

### BACKGROUND OF THE INVENTION

The subject matter disclosed herein relates to nondestructive evaluation (NDE) and probability of detection and, more particularly, to designing and manufacturing of NDE test articles having embedded features such as calibration targets or simulated defects.

Reference standards with well-defined precision geometries of both a test article and calibration target(s) are widely used in all methods of nondestructive evaluation (NDE) for a wide range of applications. NDE is also known as non-destructive testing (NDT) and non-destructive inspection (NDI). Such inspection methods are employed, for example, to validate the quality of a particular component. To employ such methods reliably, a representative reference standard is inspected to establish the inspection response to a known target, such as a flat bottom-, or round bottom-hole, in the case of many ultrasonic nondestructive evaluation methods. It is desirable that the calibration target reside in a test article (or reference standard) with the actual geometry of the component to be inspected, at the location in the geometry where the quality is to be assessed. The problem, however, is that it is difficult to produce a reference standard with calibration target(s) of the optimum geometry, location and orientation necessary to reproduce the actual component configuration, especially for components with complex geometries. In the conventional manufacture of reference standards for NDE applications, the calibration target is machined into a pre-existing test article, so only calibration targets that can be produced with conventional machining methods are practical. Furthermore, it is difficult to bury a calibration target in such a reference standard without also removing additional part material; because conventional machining must proceed from the surface of the test article. This problem places considerable limitations on the possible geometry of the test article as well as the geometry, location and orientation of the calibration targets within the test article.

A typical approach to fabricate reference standards for use in assessing and/or validating the performance of various nondestructive evaluation (NDE) methods is to machine the calibration target(s) into an existing test article. The actual calibration target can be a feature of simple geometry such as a sphere, a narrow notch, a blind or through hole, or an interior surface that is flat, cylindrical or spherical. Such simple geometries are most readily machined, and their response to a particular NDE method may be readily predicted and repeated reliably from target to target. From a practical standpoint, the geometry of the test article is usually simple as well to permit reliable machining of the calibration target(s). A flat plate or rectangular block with flat surfaces is most often used for the test article.

Probability of detection (POD) analysis is an approach for quantifying the capability, or reliability, of NDE methods applied for industrial inspections. A POD evaluation for a combination of a specific NDE method applied to a particular component geometry involves the inspection of a matrix of test articles containing flaws of varying sizes positioned at the location of interest in the test component. The location of interest is generally coincident with the region of highest in-service stress, where the presence of a flaw of sufficient size will eventually result in failure of the component. Generally a set of multiple test standards containing flaws of varying sizes is inspected via the NDE method of interest using appropriate criteria to define whether or not a particular flaw is considered to be ‘detected’ by that inspection. The data derived from such tests are then input to standardized statistical algorithms for the quantitative estimation of the POD as a function of the critical defect dimension in that particular component geometry.

Generating the set of test articles for use in a POD evaluation can be involved. To date, the matrix of test articles containing known flaws is typically gathered from actual components rejected during post-manufacture or in-service NDE inspections. Therefore, to perform a POD analysis for a particular NDE application, one waits until enough actual components containing flaws can be collected. The actual population of parts collected may or may not include the type and/or geometry of defect that the user wants to evaluate. Accordingly, there is no opportunity to schedule the acquisition of samples or specify the distribution of flaw parameters within the matrix of samples; rather, one must take whatever samples are rejected whenever they happen to be rejected. Another problem with the conventional POD approach is that there is significant uncertainty as to the actual location and geometry of the flaws found during post-manufacture or in-service NDE inspections. Various NDE methods are available to estimate the flaw location and geometry, but the most accurate characterization requires repeated sequential sectioning through the flaw. The repeated sequential sectioning destroys the flaw and the test sample in the process, so serial polishing is not a viable method to characterize flaws for use in POD analyses. In contrast, the exemplary embodiments described herein allow knowledge of the location, orientation and geometry of any flaw(s) in the matrix of test standards, because all of the critical parameters are precisely defined in the electronic representations (e.g., the CAD environment).

### BRIEF DESCRIPTION OF THE INVENTION

According to one aspect of the invention, a method in a computer system having a display for producing a representation of a probability of detection (POD) article having simulated defects on the display is described. The method can include generating a representation of a test component on the display, generating a representation of simulated defects on the display and combining the representations of the test component and the simulated defects on the display to generate a final (combined) representation. The method can further include converting the final representation to a layer-by-layer format including manufacturing parameters.

According to another aspect of the invention, a computer program product for producing a representation of a probability of detection article having simulated defects on a computer display is described. The computer program product can include instructions for causing a computer to implement a method, the method including generating a representation of a test component on the display, generating a representation of simulated defects on the display, and combining the representations of the test component and the simulated defects on the display to generate a final representation. The method can further include converting final representation to a layer-by-layer format including manufacturing parameters.

According to yet another aspect of the invention, a system for producing a representation of an article, the system including a processor, a display operatively coupled to the processor, a computer process for causing the computer to implement a method, including generating a representation of a component on the display, generating a representation of one or more simulated defects on the display, combining the representations of the component and the one or more simulated defects on the display to generate a combined representation and converting the combined representation to a layer-by-layer format including manufacturing parameters.

According to yet another aspect of the invention, an article of manufacture is described. The article of manufacture can include a test component; and one or more simulated defects disposed in the test component, the simulated defects generated from an electronic representation of the simulated defects combined with an electronic representation of the test component, wherein the test component and simulated defects are additively manufactured to produce a final POD article.

According to one aspect of the invention, a method in a computer system having a display for producing a representation of a reference standard article having calibration targets on the display is described. The method can include generating a representation of a test component on the display, generating a representation of calibration targets on the display and combining the representations of the test component and the calibration targets on the display to generate a final (combined) representation. The method can further include converting the final representation to a layer-by-layer format including manufacturing parameters.

According to yet another aspect of the invention, a system for producing a representation of an article, the system including a processor, a display operatively coupled to the processor, a computer process for causing the computer to implement a method, including generating a representation of a component on the display, generating a representation of one or more calibration targets on the display, combining the representations of the component and the one or more calibration targets on the display to generate a combined representation and converting the combined representation to a layer-by-layer format including manufacturing parameters.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a flowchart of a method for producing an NDE test article having embedded features in accordance with exemplary embodiments.

FIG. 2 illustrates an electronic representation of the 3D geometry of a test object produced in the method of FIG. 1.

FIG. 3 illustrates an electronic representation of the 3D geometry of one or more calibration targets generated in the method of FIG. 1.

FIG. 4 illustrates the combined electronic representations of the electronic representations of FIGS. 2 and 3.

FIG. 5 illustrates the combined electronic representations of the electronic representations of FIGS. 2, 3 and 4.

FIG. 6 illustrates the combined electronic representations of FIGS. 2, 3,4 and 5.

FIG. 7 illustrates the combined electronic representations of the electronic representations of FIGS. 2, 3, 4, 5 and 6.

FIG. 8 illustrates a metal reference standard manufactured by a direct laser sintering additive manufacturing process with the geometry illustrated in FIG. 7.

FIG. 9 illustrates an alternate view of the metal reference standard of FIG. 8.

FIG. 10 illustrates an electronic representation of a POD sample as produced in the method of FIG. 1.

FIG. 11 illustrates an electronic representation of simulated defects as produced in the method of FIG. 1.

FIG. 12 illustrates an electronic representation of the combination of electronic representations of the component of FIG. 10 and the simulated defects of FIG. 11.

FIGS. 13 and 14 illustrate close-up views of the simulated half-penny cracks in the pipe geometry POD sample.

FIG. 15 shows an actual POD sample containing four simulated axial cracks that was manufactured by a direct laser sintering additive manufacturing process with the pipe sample geometry illustrated in FIG. 12.

FIG. 16 illustrates close-up view of showing the simulated crack of radius 8 mm on the ID surface of the actual POD sample shown in FIG. 15.

FIG. 17 illustrates an exemplary embodiment of a system for implementing exemplary methods for producing a POD article having simulated defects in accordance with exemplary embodiments.

The detailed description explains embodiments of the invention, together with advantages and features, by way of example with reference to the drawings.

### DETAILED DESCRIPTION OF THE INVENTION

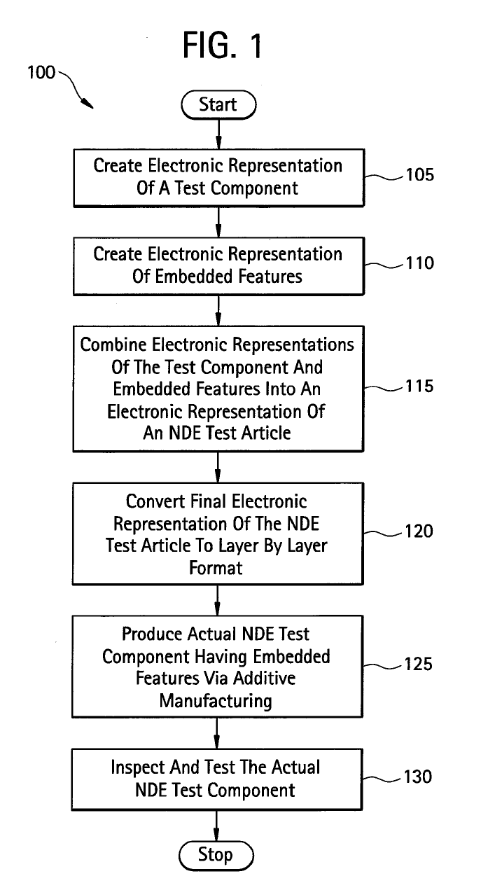

FIG. 1 illustrates a flowchart of a method 100 for producing an NDE test article having embedded features in accordance with exemplary embodiments.

The method 100 of FIG. 1 can be implemented to produce a reference standard test article having calibration target(s) in accordance with exemplary embodiments. As described herein, the simulated defects can be additively manufactured into an actual POD article. The exemplary method 100 enables the direct manufacture of calibration (or reference) standards for implementation in assessing and/or validating the performance of various NDE methods for industrial, medical or other applications. An exemplary calibration standard can include a test article that includes one or more features placed within or adjacent to the surface of the test article to represent calibration targets to be detected or imaged by one or more inspection methods during the inspection of that test article. The method 100 enables flexibility in the choice of geometry for the test article, the choice of the geometry of the calibration target(s), the location and orientation of the calibration target(s), and the material of manufacture.

The method 100 of FIG. 1 can also be implemented to produce a POD article having simulated defects in accordance with exemplary embodiments. As described herein, the simulated defects can be additively manufactured into an actual POD article. Therefore, the simulated defects can also be referred to as manufactured defects. The exemplary method 100 enables the direct manufacture of probability of detection (POD) articles for use in characterizing the performance of various NDE methods for industrial applications. The method 100 enables flexibility in the choice of geometry for the test article, the choice of the geometry of the simulated defect(s), the location and orientation of the simulated defects(s), and the material of manufacture. The resulting article of manufacture includes a component containing simulated defects that are configured to duplicate actual flaws that might occur while that component was in service. To address the issues associated with collecting a matrix of test samples for a POD analysis, the method enables the direct manufacture of NDE POD test components.

At block 105, the user creates an electronic representation of three dimensional (3D) geometry of a test component in which the user wants to evaluate an embedded feature such as a specific calibration target, or a specific defect and/or geometry of a defect at a specified location or locations within the component. In exemplary embodiments, the electronic representation may be produced in a computer aided design (CAD) or similar file. Those skilled in the art understand that various types of electronic representations can be produced at block 105. It is to be appreciated that the test components that are electronically designed can be any component in which a user desires to perform an NDE analysis.

At block 110, the user then creates an electronic representation of the 3D geometry of one or more of the embedded features such as calibration targets, or simulated defects or flaws for the test component. In exemplary embodiments, the electronic representation may be produced in a computer aided design (CAD) or similar file. Those skilled in the art understand that various types of electronic representations can be produced at block 110. It is to be appreciated that there are various types of embedded features that can be represented. For example, there are numerous types of defects that are contemplated in exemplary embodiments. The defects can include, but are not limited to cracks, porosity and the like.

At block 115, the user combines the electronic representation of the 3D geometry of the test component and the representation of the 3D geometry of the one or more embedded features to create an electronic representation of an NDE test article. In exemplary embodiments, the 3D geometry of the embedded features is placed within the 3D geometry of the test component in a desired orientation and location within the test component. In the case of simulated defects, the orientation and location of the features are selected to duplicate those characteristics of actual flaws that might occur while that component was in service. In this way a final electronic representation of the POD test component is created.

At block 120, the user can convert the final electronic representation geometry of the NDE test article (e.g.—an NDE reference standard or POD test sample) into a layer-by-layer format that includes the manufacturing parameters for each layer. In exemplary embodiments, the test component is arranged electronically in a desired orientation relative to the origin of the coordinate system used in the manufacturing machine. The component geometry is sliced into a stack of layers of the desired thickness, such that the geometry of each layer is an outline of the cross-section through the part at that particular layer location. A “toolpath” or “toolpaths” are created across the geometry of the layer. The desired manufacturing parameters are applied along the “toolpath” or “toolpaths” to create that layer of the part from whatever raw construction material is used to construct the part. The above steps are repeated for each layer of the component's geometry. Once this process is completed, an electronic computer file (or files) is generated having all of the layers, which is loaded into the particular manufacturing system to control the machine during the construction of each layer. In exemplary embodiments, other types of files are contemplated including hard copy versions. In exemplary embodiments, the embedded features are included in the component geometry and therefore part of the overall component geometry. Therefore, the embedded features (e.g.—calibration targets or simulated defects) are also stored in the computer file.

At block 125, the user creates the physical NDE test article (e.g.—an NDE reference standard or POD test sample) by implementing a layer-by-layer manufacturing process (such as a direct laser sintering method). At block 130, the NDE test article is inspected and tested with NDE techniques known in the art. For the case of a POD analysis, the POD test samples are subsequently inspected in a set containing other flawed and unflawed specimens to assess test system performance in a typical production environment. The data derived from such tests are used as inputs to standardized statistical algorithms for the quantitative estimation of the POD as a function of the critical defect dimension in a particular component geometry.

In the case where the NDE test article is a reference standard, the exemplary method therefore simultaneously creates the test component and the calibration target(s) in a single layer-by-layer manufacturing process at block 125. Such a layer-by-layer additive manufacturing process does not use a pre-existing article as the precursor to the final component, but instead produces a component from a raw material in an easily configurable form (such as a powder). Because a layer-by-layer additive manufacturing process starts with no actual object, it enables the physical creation of any conceivable geometry that fits within the useable build volume and which satisfies the spatial resolution capabilities of the particular additive manufacturing system/machine. The method 100 enables production of NDE reference standards in a broad range of construction materials (metals, ceramics, polymers, etc) supported by the many different additive manufacturing methods that are either currently available or under development.

In the case where the NDE test article is a reference standard, the exemplary embodiments described herein enable flexibility in the choice of geometry for the test article defined at block 105, as well as the choice of the geometry of the calibration target(s) defined at block 110 and the location and orientation of the calibration target(s) within the test article as determined at block 115. Therefore, the method 100 yields the design of a reference standard with calibration target(s) of the optimum geometry, location and orientation to reproduce the actual component configuration. While the electronic (CAD) representation of such an optimum reference standard for a particular component and/or inspection method can be designed, it is generally difficult to manufacture the physical object to serve as the reference standard using conventional machining methods on a pre-existing test object.

In the case where the NDE test article is a POD article, the exemplary method 100 can also be implemented to simultaneously create the test article and the simulated flaw(s) in a single layer-by-layer manufacturing process at block 125. Such a layer-by-layer additive manufacturing process does not use a pre-existing article as the precursor to the final component, but instead produces a component from a raw material in an easily configurable form (e.g., a powder). For example, a steel component can be additively manufactured by steel powder, adding the simulated defect in the layer-by-layer production of the component. Because a layer-by-layer additive manufacturing process starts with no actual object, it enables the physical creation of both component and defect geometry that fits within the useable build volume and which satisfies the spatial resolution capabilities of the particular additive manufacturing system/machine. In addition, the exemplary embodiments described herein enable production of NDE POD standards in a broad range of construction materials (e.g., metals, ceramics, polymers, etc) supported by the many different additive manufacturing methods that are either currently available or under development.

In the case where the NDE test article is a POD article, the exemplary embodiments described herein also enable flexibility in the choice of geometry for the test component specified at block 105, as well as the choice of the geometry of the simulated flaw(s) defined at block 110 and the location and orientation of the simulated defects(s) within the test article as determined at block 115. Therefore, it is possible to directly manufacture an entire matrix of POD test samples with full knowledge of the location, orientation and geometry of all of the simulated flaw(s) relative to the component geometry because all of the parameters are defined in the electronic representations (e.g., the CAD environment). Furthermore, the exemplary embodiments described herein enable designing the distribution of flaw parameters within the matrix of samples so as to ensure a robust statistical evaluation of the POD. This feature is not possible with the conventional approach, where one must take whatever samples are rejected, so the distribution of flaws is unlikely to be uniformly spread across the range of interest.

The exemplary embodiments described herein address the issues inherent with any effort to estimate the POD for a particular NDE inspection, all related to the required matrix of test samples with known flaws. As described above, the exemplary embodiments described herein enable the direct manufacture of test samples containing the flaws of interest. As such, there is no long lead time spent waiting until enough flawed samples are identified as rejected during post-manufacture or in-service NDE inspections. Another problem with the conventional POD approach is that there is significant uncertainty as to the actual location and geometry of the flaws found during post-manufacture or in-service NDE inspections. Various NDE methods are available to estimate the flaw location and geometry, but the most accurate characterization requires repeated sequential sectioning through the flaw. The repeated sequential sectioning destroys the flaw and the test sample in the process, so serial polishing is not a viable method to characterize flaws for use in POD analyses. In contrast, the exemplary embodiments described herein allow knowledge of the location, orientation and geometry of any flaw(s) in the matrix of test standards, because all of the critical parameters are precisely defined in the electronic representations (e.g., the CAD environment).

The exemplary embodiments described herein produce a broad range of POD test components for NDE applications that previously have been impossible to manufacture. As such, flexibility in the choice of geometry for the test article, as well as the choice of the geometry of the simulated flaw(s) and the location and orientation of the simulated flaw (s) within the test sample is provided. A matrix of NDT POD test components can be manufactured with the simulated defects positioned at desired locations and orientations within a test article configured in the actual geometry of the component to be inspected, thus providing an accurate and reliable sample set possible for use in experiments and statistical analyses to estimate the POD for a specific NDE inspection method applied to a particular component and flaw combination.

It is to be appreciated that the exemplary embodiments described herein are not limited to a particular additive manufacturing process or material of construction. The exemplary embodiments involve the production of non-specific NDE test articles such as reference standards with calibration target(s) or POD articles with simulated flaw(s) of any practical geometry, location and orientation that can be used across the full range of NDE inspection methods.

### Example 1

The method 100 can be applied to the case of a test article including a rectangular block 25 mm long×15 mm wide×16.5 mm tall.

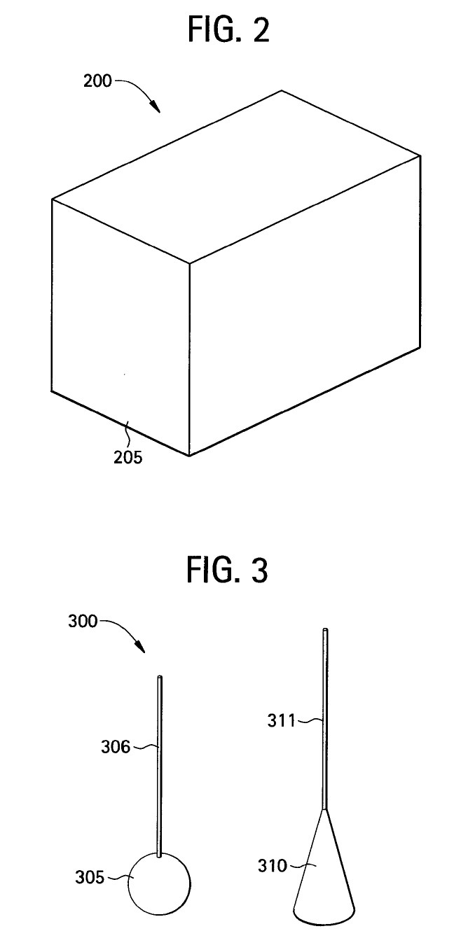

FIG. 2 illustrates an electronic representation 200 (e.g., a CAD file) of the 3D geometry of a test object produced at block 105 of FIG. 1. In this example, as described above, the test object is a rectangular block 205 that is 25 mm long×15 mm wide×16.5 mm tall.

FIG. 3 illustrates an electronic representation 300 (e.g., a CAD file) of the 3D geometry of one or more calibration targets generated at block 110 of FIG. 1. In this example, the one calibration target is a sphere 305 that is 0.125″ (3.175 mm) in diameter and the second calibration target is a cone 310 with a base diameter of 0.125″ (3.175 mm). Each target is joined to a cylinder 306, 311 that is 0.2 mm in diameter to connect them to the surface of the block 205 to mark the locations.

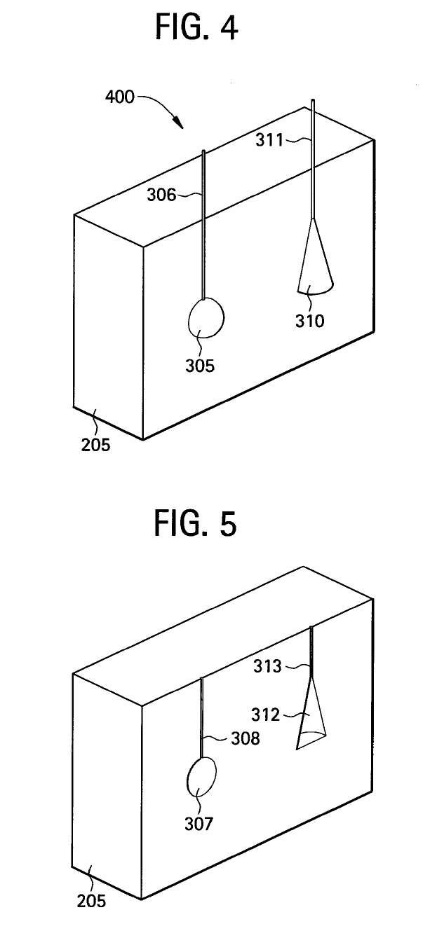

FIG. 4 illustrates the combined electronic representations 400 of the electronic representations 200, 300 of FIGS. 2 and 3. The combined CAD geometry of the calibration target(s) 305, 310 within the CAD geometry of the test object 205 generates the final CAD geometry of the desired reference standard. In this example, half of rectangular block 205 (test object) is illustrated with the two calibration target geometries superimposed at their desired locations in the reference standard.

FIG. 5 illustrates the combined electronic representations 400 of the electronic representations 200, 300 of FIGS. 2, 3 and 4. As described above, the combined CAD geometry of the calibration target(s) 305, 310 within the CAD geometry of the test object 205 generates the final CAD geometry of the desired reference standard. In this example, half of rectangular block 205 (test object) is illustrated after the two calibration target geometries have been subtracted from the rectangular block geometry, leaving the resulting calibration targets 307, 312 at their desired locations in the reference standard. Each target 307, 312 is connected to the surface of the block with a 0.2 mm dia. cylindrical channel 308, 313 to mark the location of the target.

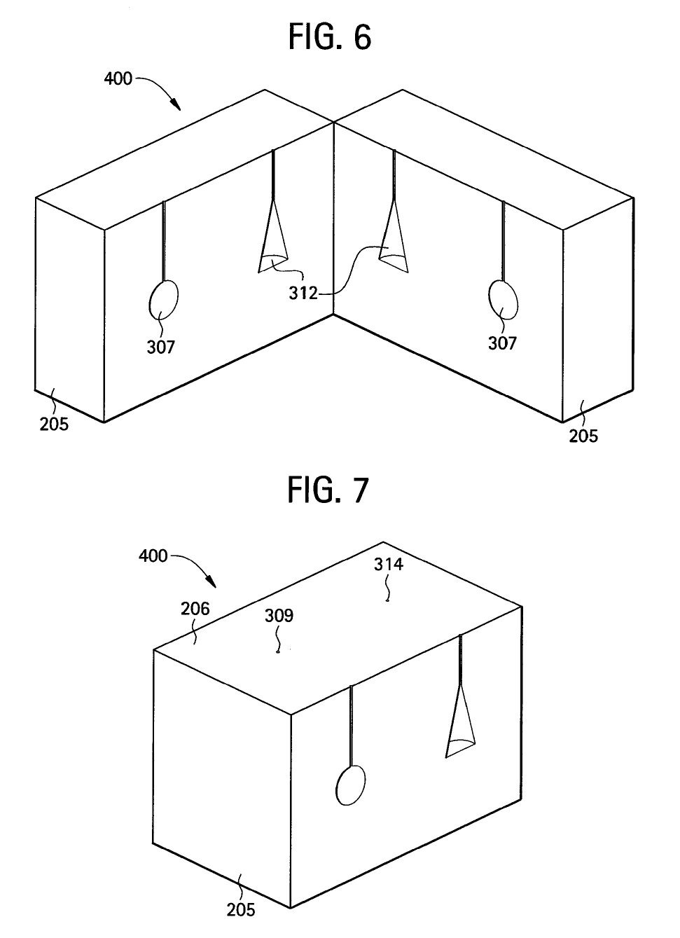

FIG. 6 illustrates the combined electronic representations 400 of FIGS. 2, 3, 4 and 5, as two halves of the block 205 of the final reference standard artificially split apart and rotated to illustrate the locations and orientation of the final calibration targets 307, 312 in the reference standard.

FIG. 7 illustrates the combined electronic representations 400 of the electronic representations 200, 300 of FIGS. 2, 3, 4, 5 and 6. At the conclusion of block 110 of FIG. 1, the final CAD geometry of the desired reference standard is in place. In this example, the reference standard includes the rectangular block 205 25 mm long×15 mm wide×16.5 mm tall (e.g., the test object) that encases the two calibration targets 307, 312—a sphere 0.125″ (3.175 mm) in diameter and a cone with a base diameter of 0.125″ (3.175 mm). The calibration targets 307, 312 are buried within the block 205 at the locations marked by the 0.2 mm dia. holes 309, 314 (corresponding to the channels 308, 313) shown in the top face 206 of the block 205. For illustrative purposes, half of each calibration target geometry are also designed in one side (the front face 207 shown of the block 205) to illustrate the positioning and orientation of the actual buried calibration targets 307, 312, which are embedded within the block.

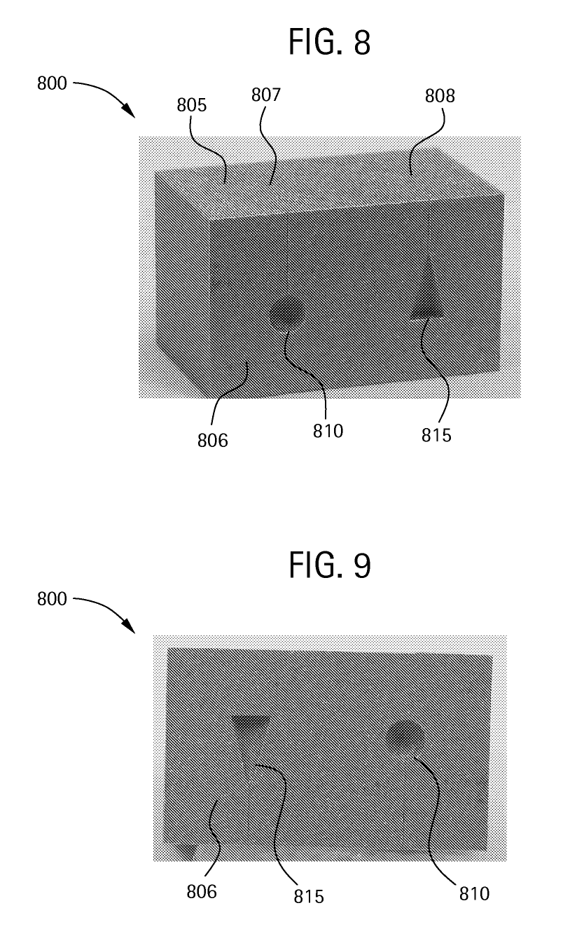

FIG. 8 illustrates a metal reference standard 800 manufactured by a direct laser sintering additive manufacturing process with the geometry illustrated in FIG. 7. In this example, the reference standard 800 includes a rectangular block 805 25 mm long×15 mm wide×16.5 mm tall (the test object) that encases two calibration targets—a sphere 0.125″ (3.175 mm) in diameter and a cone with a base diameter of 0.125″ (3.175 mm). These calibration targets are buried within the block 805 as evidenced by the holes 807, 808 leading to respective channels and to the calibration targets, as described above. For illustrative purposes, the positioning and orientation of the actual buried calibration targets is duplicated by the half-sphere 810 and half-cone 815 that were built into the front face 806 of the block 805. The calibration targets were generated during the additive manufacture of the reference standard and not machined in at a later time. FIG. 9 illustrates an alternate view of the metal reference standard 800 of FIG. 8.

### Example 2

The method 100 can also be applied to the simple case of a POD standard including a pipe geometry (i.e., the test article) with an inside diameter (ID) of 20 mm and an outside diameter (OD) of 40 mm. This POD standard is produced to include several half-penny thin notches (designed to simulate axially oriented cracks) connected to the ID surface. Four different thin notches with radii of 2.0, 4.0, 6.0 and 8.0 mm, respectively, are produced in this sample during the manufacturing. The thickness for all of the notches is 0.100 mm.

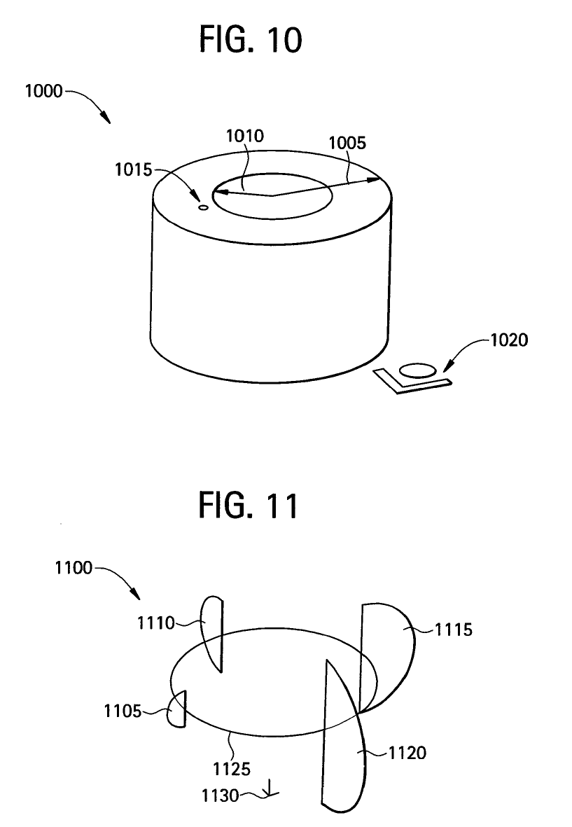

FIG. 10 illustrates an electronic representation 1000 of a POD sample as produced at block 105 of FIG. 1. As such, the POD sample is generated as an electronic representation 1000 (e.g., a CAD file) of the 3D geometry of a test component. In this example, the test component is a simulated section of a pipe 25 mm long with an outside diameter (OD) 1005 of 40 mm and an inside diameter (ID) 1010 of 20 mm. The electronic representation 1000 might include a fiducial feature or features (e.g., a hole) 1015 somewhere in or on the test component for registration of the position and/or orientation of the simulated defects as they are manufactured in the test component. The manufacture of such a fiducial feature is especially helpful when the simulated defects are located within the interior of the test component without any intersection with an external surface of the test component.

FIG. 11 illustrates an electronic representation 1100 of simulated defects 1105 as produced at block 110 of FIG. 1. As such, the simulated defects 1105, 1110, 1115, 1120 are generated as an electronic representation (e.g., a CAD file) of the 3D geometry of one or more simulated defects. In this example, four different thin half-disks with radii of 2.0, 4.0, 6.0 and 8.0 mm, respectively, include the set of simulated defects. The thickness of each of the half-disks in this example is 0.100 mm. Also illustrated is an electronic representation 1125 of a circle representing the ID 1010 of the electronic representation 1000 of FIG. 10. As such, the defects 1105, 1110, 1115, 1120 are to be oriented between the ID 1010 and the OD 1005 of the electronic representation 1000 of FIG. 10. A generalized coordinate system 1130 for the electronic representation 1100 is also illustrated.

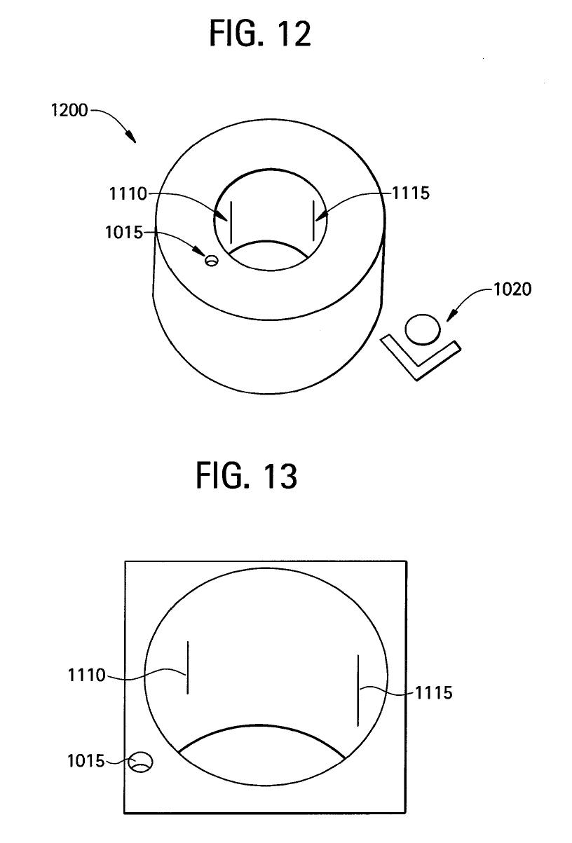

FIG. 12 illustrates an electronic representation 1200 of the combination of electronic representations 1000, 1100 of the component of FIG. 10 and the simulated defects of FIG. 11. As such, the combination of the CAD geometry of the simulated defect(s) within the CAD geometry of the test object generates the final CAD geometry of the desired POD sample. In this example, the four half-disk simulated defects 1105, 1110, 1115, 1120 shown in FIG. 11 are combined with the pipe component of FIG. 10 to create the CAD model of the final POD sample containing the half-penny simulated cracks. The view of FIG. 12 illustrates the interior of the pipe sample with the locations of the simulated defect 1110, 1115 half-penny cracks of radius 4.0 and 6.0 mm, respectively. The fiducial feature 1015 is also illustrated to register the positions of the simulated defects 1105, 1110, 1115, 1120. The one-layer fiducial pattern 1020 is used to register the orientation of the electronic representation 1000 within the build chamber of the additive manufacturing system.

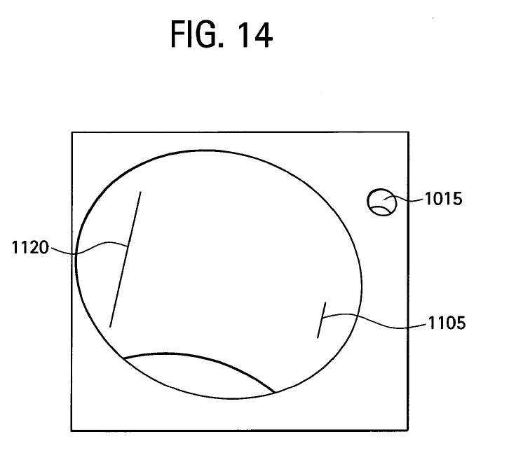

FIG. 13 illustrates a close-up view of the simulated defects 1110, 1115 with respect to the fiducial feature 1015. FIG. 14 illustrates a close-up view of the simulated defects 1105, 1120 with respect to the fiducial feature 1015.

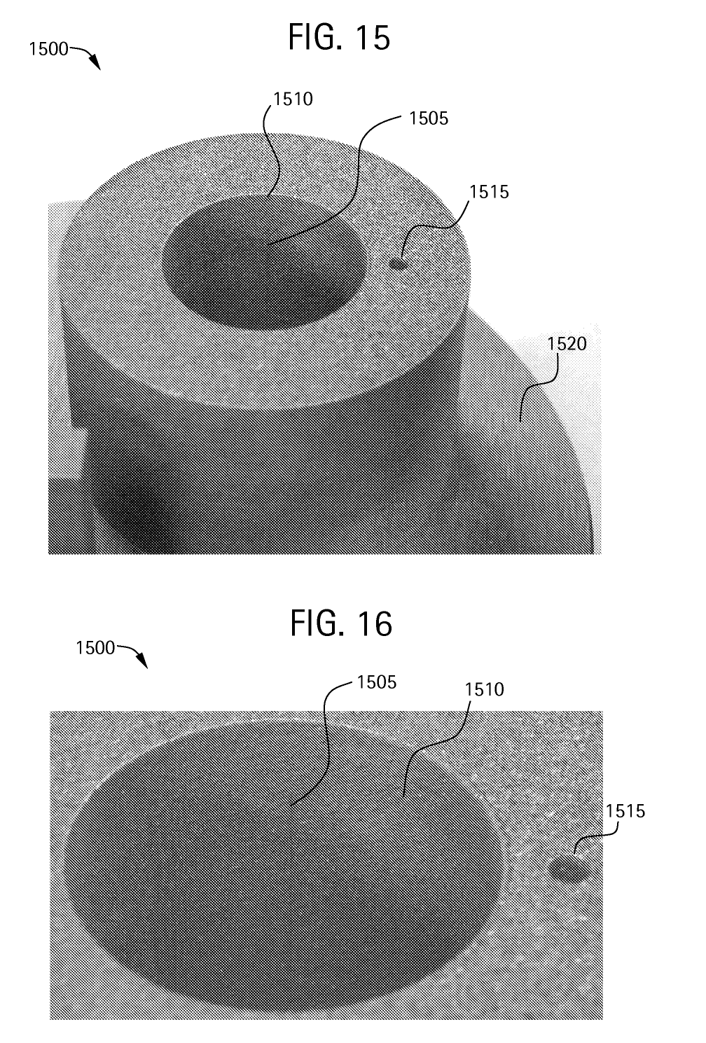

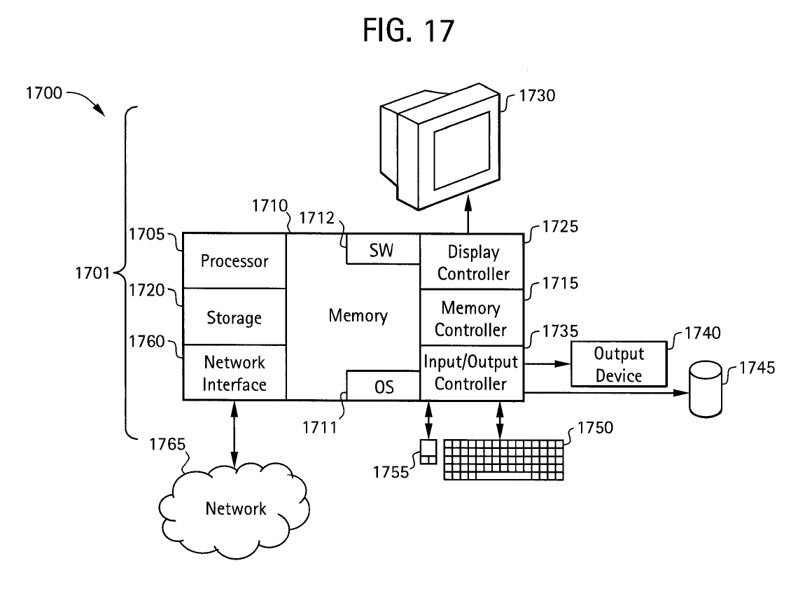

FIG. 15 shows an actual POD sample 1500 containing four simulated axial cracks that was manufactured by a direct laser sintering process with the pipe sample geometry illustrated in FIG. 12. The actual sample 1500 is manufactured as described at block 125 in FIG. 1. The pipe sample is 25 mm long with an outside diameter (OD) of 40 mm and an inside diameter (ID) of 20 mm, and it contains four simulated cracks (of radius 2.0, 4.0, 6.0 and 8.0 mm respectively), located at the ID surface of the sample. The simulated crack 1505 of radius 8 mm can be seen on the ID surface 1510 of the POD sample 1500. This view shows the POD sample 1500 still attached to the fixturing substrate 1520 used in the laser sintering process. Also shown is the shallow fiducial feature 1515 in the top face of the sample that is used to register the clock positions of the simulated flaws. It is to be appreciated that the simulated flaws are created during the additive manufacture of the POD sample 1500 and not subsequently machined. FIG. 16 illustrates a close-up view showing the simulated crack 1505 of radius 8 mm on the ID surface 1510 of the actual POD sample 1500 shown in FIG. 15.

As described above, electronic representations are generated and combined as well as converted to a layer-by-layer format. These electronic representations and formats are advantageously generated in a computer system as now described. FIG. 17 illustrates an exemplary embodiment of a system 1700 for implementing exemplary methods for manufacturing an actual NDE test article having simulated defects in accordance with exemplary embodiments. The exemplary methods for manufacturing an actual NDE test article implementing electronic representations described herein can be implemented in software 1712 (e.g., firmware), hardware, or a combination thereof. In exemplary embodiments, the methods described herein are implemented in software 1712, as an executable program, and is executed by a special or general-purpose digital computer, such as a personal computer, workstation, minicomputer, or mainframe computer. The system 1700 therefore includes general-purpose computer 1701.

In exemplary embodiments, in terms of hardware architecture, as shown in FIG. 17, the computer 1701 includes a processor 1705, memory 1710 coupled to a memory controller 1715, and one or more input and/or output (I/O) devices 1740, 1745 (or peripherals) that are communicatively coupled via a local input/output controller 1735. The input/output controller 1735 can be, for example but not limited to, one or more buses or other wired or wireless connections, as is known in the art. The input/output controller 1735 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1705 is a hardware device for executing software 1712 particularly, which is stored in memory 1710. The processor 1705 can be any custom made or commercially available processor, a central processing unit (CPU), an auxiliary processor among several processors associated with the computer 1701, a semiconductor based microprocessor (in the form of a microchip or chip set), a macroprocessor, or generally any device for executing software instructions.

The memory 1710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 1710 may incorporate electronic, magnetic, optical, and/or other types of storage media. Note that the memory 1710 can have a distributed architecture, where various components are situated remote from one another, but can be accessed by the processor 1705.

The software (SW) 1712 in memory 1710 may include one or more separate programs, each of which comprises an ordered listing of executable instructions for implementing logical functions. In the example of FIG. 17, the software 1712 in the memory 1710 includes the methods for manufacturing an actual POD article described herein in accordance with exemplary embodiments and a suitable operating system (OS) 1711. The operating system 1711 essentially controls the execution of other computer programs, such as the methods for manufacturing an actual POD article described herein, and provides scheduling, input-output control, file and data management, memory management, and communication control and related services.

The methods for manufacturing an actual NDE test article described herein may be in the form of a source program, executable program (object code), script, or any other entity comprising a set of instructions to be performed. When a source program, then the program needs to be translated via a compiler, assembler, interpreter, or the like, which may or may not be included within the memory 1710, so as to operate properly in connection with the OS 1711. Furthermore, the methods for manufacturing an actual POD article can be written as an object oriented programming language, which has classes of data and methods, or a procedure programming language, which has routines, subroutines, and/or functions.

In exemplary embodiments, a conventional keyboard 1750 and mouse 1755 can be coupled to the input/output controller 1735. Other output devices such as the I/O devices 1740, 1745 may include input devices, for example but not limited to a printer, a scanner, microphone, and the like. Finally, the I/O devices 1740, 1745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 1700 can further include a display controller 1725 coupled to a display 1730. The display 1730 may be implemented to render the electronic representations and CAD coordinate systems related to the NDE test articles as described herein.

In exemplary embodiments, the system 1700 can further include a network interface 1760 for coupling to a network 1765. The network 1765 can be an IP-based network for communication between the computer 1701 and any external server, client and the like via a broadband connection. The network 1765 transmits and receives data between the computer 1701 and external systems. In exemplary embodiments, network 1765 can be a managed IP network administered by a service provider. The network 1765 may be implemented in a wireless fashion, e.g., using wireless protocols and technologies, such as WiFi, WiMax, etc. The network 1765 can also be a packet-switched network such as a local area network, wide area network, metropolitan area network, Internet network, or other similar type of network environment. The network 1765 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 1701 is a PC, workstation, intelligent device or the like, the software 1712 in the memory 1710 may further include a basic input output system (BIOS) (omitted for simplicity). The BIOS is a set of essential software routines that initialize and test hardware at startup, start the OS 1711, and support the transfer of data among the hardware devices. The BIOS is stored in ROM so that the BIOS can be executed when the computer 1701 is activated.

When the computer 1701 is in operation, the processor 1705 is configured to execute software 1712 stored within the memory 1710, to communicate data to and from the memory 1710, and to generally control operations of the computer 1701 pursuant to the software 1712. The methods for manufacturing an actual NDE test article described herein and the OS 1711, in whole or in part, but typically the latter, are read by the processor 1705, perhaps buffered within the processor 1705, and then executed.

When the systems and methods described herein are implemented in software 1712, as is shown in FIG. 17, it the methods can be stored on any computer readable medium, such as storage 1720, for use by or in connection with any computer related system or method. In the context of this document, a computer readable medium is an electronic, magnetic, optical, or other physical device or means that can contain or store a computer program for use by or in connection with a computer related system or method. The methods for manufacturing an actual NDE test article described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the methods for manufacturing an actual NDE test article are implemented in hardware, the methods for manufacturing an actual NDE test article described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include the production of reference standards assessing the performance of various nondestructive inspection methods with flexibility in the choice of geometry for the test article, as well as the choice of the geometry of the calibration target(s) and the location and orientation of the calibration target(s) within the test article. Furthermore, reference standards may be produced with calibration targets buried below the part surface so as to be completely encased in the material of the test article. This feature is not possible with reference standards produced using conventional machining methods on a pre-existing test article. Technical effects also include the production of precision POD test samples for use in estimating the POD to assess the performance of various nondestructive inspection methods with previously impossible complete flexibility in the choice of geometry for the test article, as well as the choice of the geometry of the simulated flaw(s) and the location and orientation of the simulated flaw(s) within the test article. Technical effects further include a level of control to specify all parameters critical to the matrix of test samples required to conduct a POD analysis. The methods and systems described herein can be implemented for the manufacture of the actual POD article. Additive manufacturing is implemented to achieve the resulting POD article. The method for creating the representation in electronic (CAD) format is part of the input implemented for the actual additive manufacturing of the POD article with simulated defects. In most cases it is difficult to implement conventional machining methods (subtractive manufacturing) to physically manufacture the POD article with simulated defects, so it is desirable instead to generate the article with simulated defects via additive manufacturing. For example, additive manufacturing allows manufacture of simulated defects that are completely buried in the interior of a POD test component without intersecting any external surface of the POD test component. As described herein, the systems and methods provide electronic representations that can be implemented for an additive manufacturing process that makes possible the manufacture of the actual physical POD test component containing simulated defects.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for producing a representation of an article, the method comprising:
generating a representation of a component;
generating a representation of one or more simulated defects;
combining the representations of the component and the one or more simulated defects to generate a combined representation; and
converting the combined representation to a layer-by-layer format including manufacturing parameters.

2. The method as claimed in claim 1 wherein the representations of the component and of the one or more simulated defects are electronic representations stored in a computer aided design (CAD) file.

3. The method as claimed in claim 1 wherein the component is a probability of detection (POD) test component.

4. The method as claimed in claim 1 further comprising orienting the one or more simulated defects in a position and orientation within the component to duplicate characteristics of actual flaws that can occur in the component.

5. The method as claimed in claim 1 wherein the manufacturing parameters are additive manufacturing parameters.

6. The method as claimed in claim 1 further comprising generating a file including all layers of the layer-by-layer format.

7. The method as claimed in claim 6 wherein the file is configured to provide the manufacturing parameters to an additive manufacturing system.

8. The method as claimed in claim 1 wherein the electronic representation includes one or more fiducial features to register the position and orientation of the one or more simulated defects with respect to the actual component.

9. A computer program product for producing a representation of an article, the computer program product including instructions for causing a computer to implement a computer method, the computer method comprising:
generating a representation of a component;
generating a representation of one or more simulated defects;
combining the representations of the component and the one or more simulated defects to generate a combined representation; and
converting the combined representation to a layer-by-layer format including manufacturing parameters.

10. The computer program product as claimed in claim 9 wherein the representations are electronic representations stored in a computer aided design (CAD) file.

11. The computer program product as claimed in claim 9 wherein the component is a probability of detection (POD) test component.

12. The computer program product as claimed in claim 9 wherein the method further comprises orienting the one or more simulated defects in a position and orientation within the component to duplicate characteristics of actual flaws that can occur in the component.

13. The computer program product as claimed in claim 9 wherein the manufacturing parameters are additive manufacturing parameters.

14. The computer program product as claimed in claim 9 wherein the method further comprises generating a file including all layers of the layer-by-layer format.

15. The computer program product as claimed in claim 14 wherein the file is configured to provide the manufacturing parameters to an additive manufacturing system.

16. The computer program product as claimed in claim 9 wherein the electronic representation includes one or more fiducial features to register the position and orientation of the simulated defects with respect to the actual component.

17. A system for producing a representation of an article, the system comprising:
a processor;
a display operatively coupled to the processor;
a computer process for causing the computer to implement a method, comprising:
generating a representation of a component on the display;
generating a representation of one or more simulated defects on the display;
combining the representations of the component and the one or more simulated defects on the display to generate a combined representation; and
converting the combined representation to a layer-by-layer format including manufacturing parameters.

18. The system as claimed in claim 17 wherein the manufacturing parameters are additive manufacturing parameters.

19. An article of manufacture, comprising:
a test component; and
one or more simulated defects disposed in the test component, the simulated defects generated from an electronic representation of the simulated defects combined with an electronic representation of the test component,
wherein the test component and simulated defects are additively manufactured.

20. The article of manufacture as claimed in claim 19 further comprising a fiducial feature to register clock positions of the simulated defects with respect to the test component.

21. A method for producing a representation of an article on the display, the method comprising:
generating a representation of a component;
generating a representation of one or more calibration targets;
combining the representations of the component and the one or more calibration targets to generate a combined representation; and
converting the combined representation to a layer-by-layer format including manufacturing parameters.

22. The method as claimed in claim 21 wherein the representations of the component and of the one or more calibration targets are electronic representations stored in a computer aided design (CAD) file.

23. The method as claimed in claim 21 wherein the component is a reference standard test component.

24. The method as claimed in claim 21 further comprising orienting the one or more calibration targets in a position and orientation within the component to establish an inspection to a known target.

25. The method as claimed in claim 21 wherein the manufacturing parameters are additive manufacturing parameters.

26. The method as claimed in claim 21 further comprising generating a file including all layers of the layer-by-layer format.

27. The method as claimed in claim 26 wherein the file is configured to provide the manufacturing parameters to an additive manufacturing system.

28. A system for producing a representation of an article, the system comprising:
a processor;
a display operatively coupled to the processor;
a computer process for causing the computer to implement a method, comprising:
generating a representation of a component on the display;
generating a representation of one or more calibration targets on the display;
combining the representations of the component and the one or more calibration targets on the display to generate a combined representation; and
converting the combined representation to a layer-by-layer format including manufacturing parameters.

29. The system as claimed in claim 28 wherein the manufacturing parameters are additive manufacturing parameters.
